(19) United States
(12) Patent Application Publication
(10) Pub. No.: US 2026/0304122 A1
(43) Pub. Date: Oct. 1, 2026

(54) Ephemeral Codes for Thread Credential Sharing

(71) Applicant: Google LLC, Mountain View, CA (US)

(72) Inventors: Jonathan Wing-Yan Hui, Belmont, CA (US); Kevin Po, Mountain View, CA (US); Matt Daniel Smith, San Jose, CA (US)

(73) Assignee: Google LLC, Mountain View, CA (US)

(21) Appl. No.: 19/477,029

(22) PCT Filed: May 17, 2024
(86) PCT No.: PCT/US2024/030069

§ 371 Date: Oct. 20, 2025

Related U.S. Application Data
(60) Provisional application No. 63/503,361, filed on May 19, 2023.

(51) Int. Cl. H04W 12/08; H04L 61/4511; H04W 8/00; H04W 76/10; H04W 84/18

(52) U.S. Cl. CPC H04W 12/08; H04L 61/4511; H04W 8/005; H04W 76/10; H04W 84/18

(57) ABSTRACT

Techniques and devices for joining a first Thread device to a Thread network are described. A second Thread device is discovered on the Thread network. Based on the discovering, an ephemeral code is requested from the second Thread device, the request directing the second Thread device to generate the ephemeral code. Using the ephemeral code, a secure session is established between the first Thread device and the second Thread device (or a commissioner device and the second Thread device), the establishing being effective to direct the second Thread device to transfer credentials for the Thread network to the first Thread device.

### BACKGROUND

Using networking to connect devices to each other and to cloud-based services is increasingly popular for sensing environmental conditions, controlling equipment, and providing information and alerts to users for residential and commercial buildings. Many devices on wireless networks are designed to operate for extended periods of time on battery-power which limits the available computing, user interface, and radio resources in the devices.

Thread is a mesh networking technology. As such, Thread's connectivity reach and robustness increases as more devices are added to the same Thread network. Thread relies on a network-wide shared key to secure and authenticate all data frames. As such, all Thread devices in the same Thread network must be configured with the same Thread Credentials. There are existing solutions for sharing Thread credentials, but they all have barriers to adoption, thus there is an opportunity for a standard solution that makes it easier for any user of Thread devices to share Thread credentials between the Thread devices.

### SUMMARY

In aspects, methods, devices, systems, and means for ephemeral codes for Thread credential sharing are described in which a first thread device is joined to a Thread network by a commissioner device. The commissioner device discovers a second Thread device operating on the Thread network. Based on the discovering, the commissioner device requests an ephemeral code from the second Thread device, the request directing the second Thread device to generate the ephemeral code. Using the ephemeral code, the commissioner device establishes a secure session with the second Thread device, the establishing being effective to direct the second Thread device to transfer credentials for the Thread network to the first Thread device to enable the first Thread device to join the Thread network.

In aspects, methods, devices, systems, and means for ephemeral codes for Thread credential sharing are described in which a first thread network is merged with a second thread network. A commissioner device requests a first Thread device in the first Thread network to generate an ephemeral code. The commissioner device provides the ephemeral code to a second Thread device in the second Thread network that is effective to direct the second Thread device to: use the ephemeral code to establish a secure session with the first Thread device, and negotiate, with the first Thread device, common Thread credentials to use for the merged network, the negotiating being effective to merge the first Thread network and the second Thread network into a single Thread network that uses the common Thread credentials.

The details of one or more implementations are set forth in the accompanying drawings and the following description. Other features and advantages will be apparent from the description and drawings and from the claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

Aspects of ephemeral codes for Thread credential sharing are described with reference to the following drawings. The same numbers are used throughout the drawings to reference like features and components:

FIG. 1 illustrates an example mesh network system in which various aspects of ephemeral codes for Thread credential sharing can be implemented.

FIG. 2 illustrates an example environment in which various aspects of ephemeral codes for Thread credential sharing can be implemented.

FIG. 3 illustrates an example method of ephemeral codes for Thread credential sharing as in accordance with aspects of the techniques described herein.

FIG. 4 illustrates an example method of ephemeral codes for Thread credential sharing as in accordance with aspects of the techniques described herein.

FIG. 5 illustrates an example environment in which a mesh network can be implemented in accordance with aspects of the techniques described herein.

FIG. 6 illustrates an example wireless mesh network device that can be implemented in a mesh network environment in accordance with one or more aspects of the techniques described herein.

FIG. 7 illustrates an example system with an example device that can implement aspects of ephemeral codes for Thread credential sharing.

### DETAILED DESCRIPTION

This document describes techniques and devices to simplify joining devices to Thread networks and merging Thread networks. Thread border routers provide Internet Protocol (IP) connectivity between a Thread network and other IP-based networks (e.g., Wi-Fi and Ethernet). While it is possible for different Thread networks to communicate via Thread border routers by using Wi-Fi and/or Ethernet as an intermediate hop, Thread border routers do not work together to extend the reach of a given Thread network. This complicates the task of deploying Thread. Existing solutions for sharing Thread credentials rely on the Application Programming Interfaces (APIs) of mobile apps to share Thread credentials between the Thread devices, but product vendors must implement and rely on mobile apps for this solution. Also, vendor-specific solutions and partnerships exist to share Thread credentials, but these are specific to the given vendor and fail to provide a more universal solution to sharing Thread credentials. Aspects of ephemeral codes for Thread credential sharing provide a standard solution that improves ease of use for sharing Thread credentials between Thread devices. A secured session established using the ephemeral codes can generally be used to administer a Thread device or a Thread network, the retrieving of credentials for commissioning being an example of such an administrative task.

Wi-Fi devices are typically configured using a common passphrase. The user is responsible for managing and inputting the passphrase. Because a user is responsible for generating and managing the passphrase, the passphrase is often easy to guess and can make it easy for an attacker to compromise a Wi-Fi network.

Some Wi-Fi devices have a special code printed on them that may be used to administer the device. However, anyone with physical access can obtain the code. Additionally, because the code is printed on device, it cannot be changed if the code is compromised.

### Example Environment

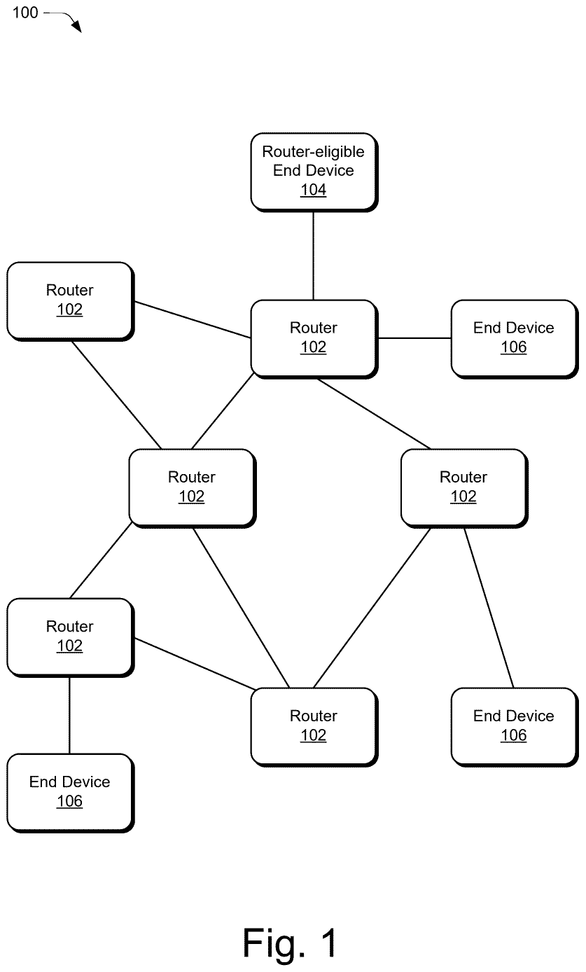

FIG. 1 illustrates an example system as a mesh network 100 in which aspects of ephemeral codes for Thread credential sharing can be implemented. The mesh network 100 is a wireless mesh network that includes routers 102, a router-eligible end device 104, and end devices 106. The routers 102, the router-eligible end device 104, and the end devices 106, each include a mesh network interface for communication over the mesh network. The routers 102 receive and transmit packet data over the respective mesh network interfaces. The routers 102 also route traffic across the mesh network 100.

The router-eligible end device 104 is representative of router-eligible end devices that are located at leaf nodes of the mesh network topology and are not actively routing traffic to other nodes in the mesh network 100. The router-eligible device 104 is capable of becoming a router 102 when the router-eligible device 104 is connected to additional mesh network devices. The end devices 106 are devices that can communicate using the mesh network 100, but lack the capability, beyond simply forwarding packets to its parent router 102, to route traffic in the mesh network 100. For example, a battery-powered sensor is one type of end device 106.

Some end devices 106 may power down (i.e., sleep) some operations or hardware for a portion of the time the end device 106 is operational. For example, the end device 106 may power down radios or network interfaces, to conserve power between operations that require a connection to the mesh network 100. For example, a battery-powered temperature sensor may only be awake periodically to transmit a report of temperature, and then the temperature sensor sleeps until the next time the temperature sensor reports. When the end devices 106 sleep, the end devices 106 are not actively connected to the mesh network 100 to respond to address queries or to receive data packets over the mesh network 100.

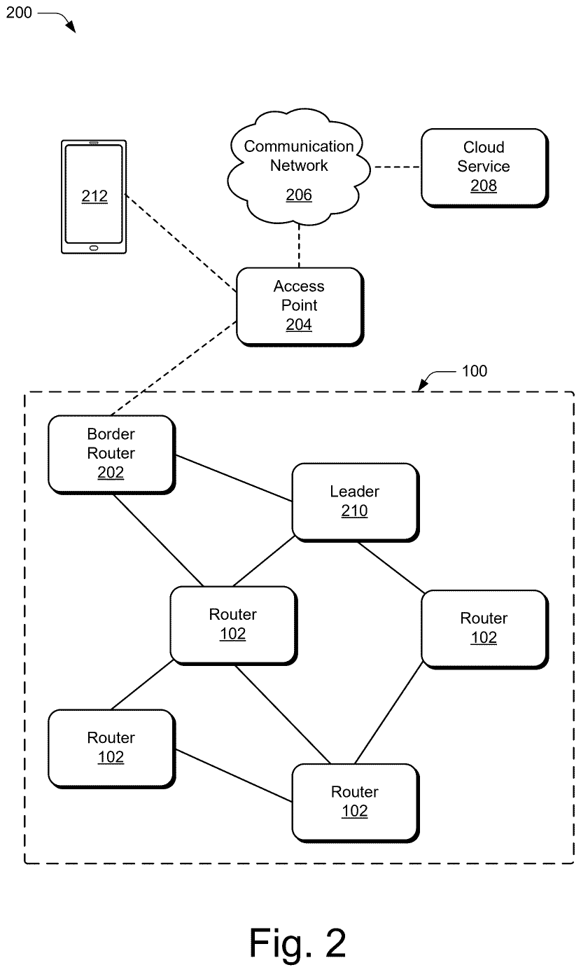

FIG. 2 illustrates an example environment 200 in which various aspects of ephemeral codes for Thread credential sharing can be implemented. The environment 200 includes the mesh network 100, in which some routers 102 are performing specific roles in the mesh network 100.

A border router 202 (also known as a gateway and/or an edge router) is one of the routers 102. The border router 202 includes the mesh network interface, as well as a second interface for communication with an external network, outside the mesh network 100. The border router 202 connects to an access point 204 over the external network. For example, the access point 204 may be an Ethernet router, a Wi-Fi access point, a cellular base station, or any other suitable device for bridging different types of networks. Although a single border router 202 is shown in FIG. 2, for the sake of clarity, the mesh network 100 may have any number of border routers 202, which may connect to any number of external networks. In another implementation, an end device 106 may operate as a border router 202. In this case the end device operating as the border router 202 is routing traffic between the mesh network 100 and an external network, but not routing traffic between other mesh network devices. The border router 106, or any other Thread device that includes a Thread interface and an interface to an external network can act as a border agent between the Thread network and a commissioner device (e.g., commissioner device 210) for commissioning devices to a Thread network.

The access point 204 connects to a communication network 206, such as the Internet. A cloud service 208, which is connected via the communication network 206, provides services related to and/or using the devices within the mesh network 100. By way of example, and not limitation, the cloud service 208 provides applications that include connecting end user devices, such as smart phones, tablets, and the like, to devices in the mesh network 100, processing and presenting data acquired in the mesh network 100 to end users, linking devices in one or more mesh networks 100 to user accounts of the cloud service 208, provisioning and updating devices in the mesh network 100, and so forth. Alternatively or optionally, services described in relation to the cloud service 208 may be distributed completely or partially between the cloud service 208 and a hub device (e.g., the border router 202, a security hub, or the like) that is installed at the structure where the mesh network devices are installed. The storage location of traits, resources, and interfaces of mesh network devices or structure-related information may be dynamically distributed in any suitable fashion between the cloud service 208 and the hub device.

One of the routers 102 performs the role of a leader 210 for the mesh network 100. The leader 210 manages router identifier assignment, is the central arbiter of network configuration information, and propagates network data, which includes the network configuration information, for the mesh network 100.

### Device Joining Using Ephemeral Codes for Thread Credential Sharing

When joining (commissioning) a Thread device to an existing Thread network, a joining device needs to obtain the credentials for the existing Thread network to communicate on that Thread network. To initiate the commissioning of a new Thread device to a Thread network, the user initiates a discovery process (e.g., using an app on the commissioner device 210). The discovery process may use any suitable network-layer discovery service. For example, the discovery process may use Domain Name Service-Service Discovery (DNS-SD) or multicast DNS (mDNS) over Wi-Fi and/or Ethernet to discover Thread border routers (e.g. border router 106). In another example, the discovery process may use DNS-SD over unicast DNS to discover Thread devices that are publishing their services via a Service Registration Protocol (SRP). In a further example, the discovery process may use link-layer discovery services such as using a Mesh Link Establishment (MLE) Discovery Request over a Thread/IEEE 802.15.4 radio link. In an additional example, the discovery process may utilize application-specific databases, such as querying a cloud database for other devices in a structure. In a further example, Bluetooth Low Energy (BLE) beacons or Near Field Communication (NFC) can be used to discover Thread devices.

After discovering one or more Thread devices or networks, the user selects an existing Thread device or network to which they want to join the new Thread device. User requests, made via the app on the commissioner device 210, direct the existing Thread device (or a device (border agent) in the selected Thread network, e.g., a border router 106) to generate an ephemeral code.

The selected Thread device, acting as the border agent, generates an ephemeral code (passcode) that is in one aspect a random, one-time usable, and valid for a limited time period. An ephemeral code in one embodiment can be a code which exists or is valid only for a short period of time, typically until a task or a condition is fulfilled. An ephemeral code can serve an immediate purpose and is then discarded (e.g. it is not stored). This means an ephemeral pre-shared key for the commissioner (ePSKc) can only be successfully used for authentication once after being explicitly enabled by a user on the border agent, and then used by a commissioner candidate within a short, designated time window to start a Transport Layer Security (TLS) or Datagram Transport Layer Security (DTLS) session to the border agent. This protects the Thread network from brute-force, code-guessing attacks from bad actors. In one alternative, the ephemeral code may be displayed in human-readable characters, such as via an app on a mobile device. In this example, the ephemeral code is easy for humans to read and type (e.g. simple alphabet, short in length), which also means ephemeral code is low entropy (relatively easy to guess or hack). In another alternative, the ephemeral code may be encoded using a machine-readable image (e.g., a QR code). In this example, the ephemeral code may be more complex (higher entropy). In another alternative, the ephemeral code may be communicated via other mediums, such as NFC, human-audible sound, ultrasound, visible or infrared light, etc. For example, the ephemeral code (passcode) includes eight random numeric digits and a single check digit added using a Verhoeff algorithm.

To continue with joining the new device, the user transfers the ephemeral code to the new Thread device. For example, the user may transfer the ephemeral code using a keyboard entry, voice input, or image processing (e.g., photographing the QR code using a commissioning device, such as via the commissioning app on the commissioner device 210. Alternatively, while ephemeral code may be used by the joiner device itself, the ephemeral code may also be used by the commissioner and not the Thread joiner itself. For example, a commissioner device can use the ephemeral code to establish a secure session with the existing Thread device and retrieve the Thread credentials.

The user (commissioning device) establishes a secure session using the ephemeral code. The secure session is established using Transport Layer Security (TLS) or Datagram Transport Layer Security (DTLS) with an Elliptic Curve Cryptography (ECC) variant of Password Authenticated Key Exchange by Juggling (J-PAKE) (ECJ-PAKE). In one alternative, the new Thread device may establish a secure session directly. This allows the new Thread device to retrieve Thread credentials directly. In another example, the new Thread device may communicate over an IP-based network (e.g. Wi-Fi and/or Ethernet). In a further example, the new Thread device may communicate over raw link-layer frames, such as IEEE 802.15.4 frames or BLE connections. In another alternative, a separate device (e.g. smart phone, commissioner device) may establish the secure session. For example, a Thread commissioner device may retrieve Thread credentials and provide them to the new Thread device over a BLE connection. Once the credentials have been exchanged, the secure session is closed, and the new Thread device has completed joining the Thread network.

### Merging Thread Networks Using Ephemeral Codes for Thread Credential Sharing

Multiple Thread networks can be merged by using ephemeral codes. A user and/or service may discover the presence of multiple Thread networks (using any of the discovery mechanisms mentioned above) and request to merge the multiple Thread networks into a single Thread network. The user requests (e.g., via a commissioner device) a first Thread device in a first Thread network to generate an ephemeral code to begin the merge process. The user provides the ephemeral code to a second Thread device in a second Thread network. The second Thread device then uses the ephemeral code to establish a secure session with the first Thread device (e.g., using the mechanisms described above). The first Thread device and the second Thread device negotiate common Thread credentials to use for the merged network. For example, the negotiation may include determining which network credential of the two Thread networks is the most recent, based on timestamp information included in the commissioning datasets of the two networks and selecting the most recent update to the commissioning credentials in any network fragment as the credentials for the merged Thread network. The two devices apply the common Thread credentials to devices in their respective networks.

In another alternative, the user requests the first Thread device in the first network and the second Thread device in the second Thread network to generate an ephemeral code to begin the merge process. An agent (e.g., a commissioner device) establishes secure sessions to the two Thread devices using the ephemeral codes. Alternatively, if the agent already has credentials for one of the Thread networks, the agent only needs to obtain an ephemeral code from a device on the network for which the agent does not possess credentials. The agent determines common Thread credentials to use. The agent configures each Thread network with the common Thread credentials.

### Example Methods

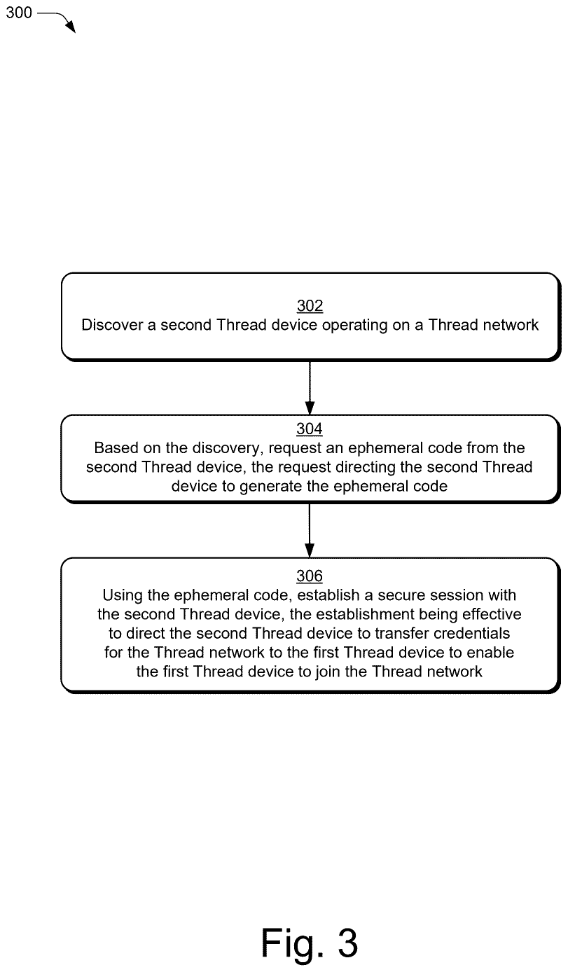

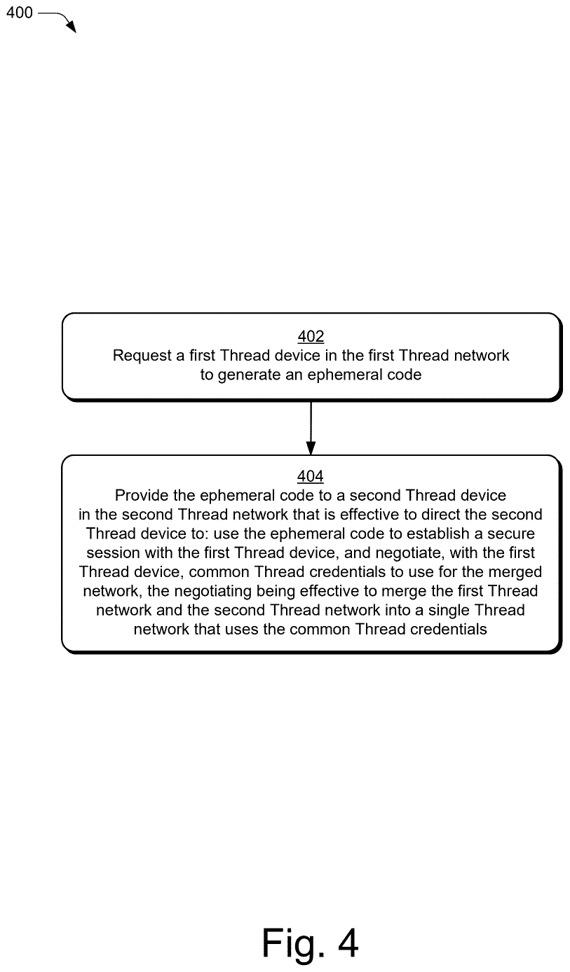

Example methods 300 and 400 are described with reference to FIGS. 3 and 4 in accordance with one or more aspects of ephemeral codes for Thread credential sharing. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 3 illustrates example method(s) 300 of ephemeral codes for Thread credential sharing as generally related to joining a first Thread device to second Thread device or a Thread network. At block 302, the second Thread device operating on the Thread network is discovered. For example, the first Thread device (e.g., a router 102, a router-eligible device 104, or an end device 106) or a user device (e.g., a commissioner device 210), such as a commissioning app on a mobile device, uses a discovery protocol to discover the second Thread device.

At block 304, based on the discovering, an ephemeral code is requested from the second Thread device, the request directing the second Thread device to generate the ephemeral code. For example, based on receiving the request, the second Thread device generates a random ephemeral code that remains valid for a limited period of time.

At block 306, using the ephemeral code, establishing a secure session with the second Thread device, the establishing being effective to direct the second Thread device to transfer credentials for the Thread network to the first Thread device to enable the first Thread device to join the Thread network. For example, using the secure session, the credentials for the Thread network (e.g., wireless mesh network 100) are transferred to the first Thread device enabling the first Thread device to communicate over the Thread network.

FIG. 4 illustrates example method(s) 400 of ephemeral codes for Thread credential sharing as generally related to merging a first Thread network and a second Thread network. At block 402, a first Thread device in the first Thread network is requested to generate an ephemeral code. For example, a commissioning app on a user device (e.g., a commissioner device 210) communicates with the first Thread device (e.g., a router 102, a router-eligible device 104, or an end device 106) to request the generation of a random ephemeral code.

At block 404, the ephemeral code is provided to a second Thread device in the second Thread network that is effective to direct the second Thread device to: use the ephemeral code to establish a secure session with the first Thread device, and negotiate, with the first Thread device, common Thread credentials to use for the merged network, the negotiating being effective to merge the first Thread network and the second Thread network into a single Thread network that uses the common Thread credentials. For example, the commissioner device transfers the ephemeral code to the second device (e.g., a router 102, a router-eligible device 104, or an end device 106), using suitable communication technology, such as Wi-Fi, Ethernet, or Thread, that is effective to direct the second Thread device to: use the ephemeral code to establish a secure session with the first Thread device, and negotiate, with the first Thread device, common Thread credentials to use for the merged network, the negotiating being effective to merge the first Thread network and the second Thread network into a single Thread network that uses the common Thread credentials.

### Example Environments and Devices

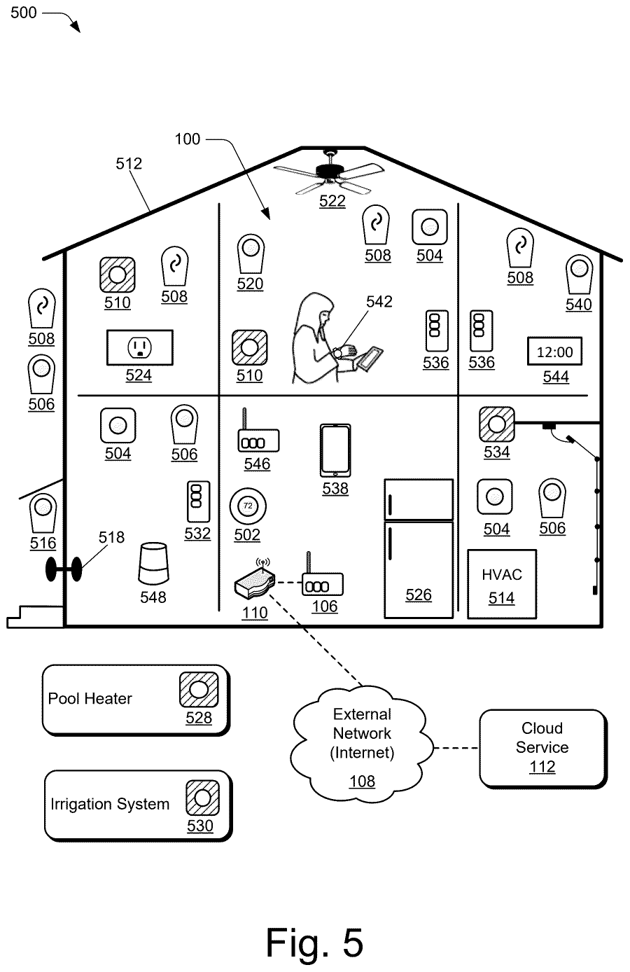

FIG. 5 illustrates an example environment 500 in which a mesh network 100, as described with reference to FIG. 1, and aspects of ephemeral codes for Thread credential sharing can be implemented. Generally, the environment 500 includes the mesh network 100 implemented as part of a home or other type of structure with any number of wireless and/or wired network devices that are configured for communication in a wireless network. For example, the wireless network devices can include a thermostat 502, hazard detectors 504 (e.g., for smoke and/or carbon monoxide), cameras 506 (e.g., indoor and outdoor), lighting units 508 (e.g., indoor and outdoor), and any other types of wireless network devices 510 that are implemented inside and/or outside of a structure 512 (e.g., in a home environment). In this example, the mesh network devices can also include any of the previously described devices, such as a border router 202, as well as any of the devices implemented as a router device 102, and/or as an end device 106.

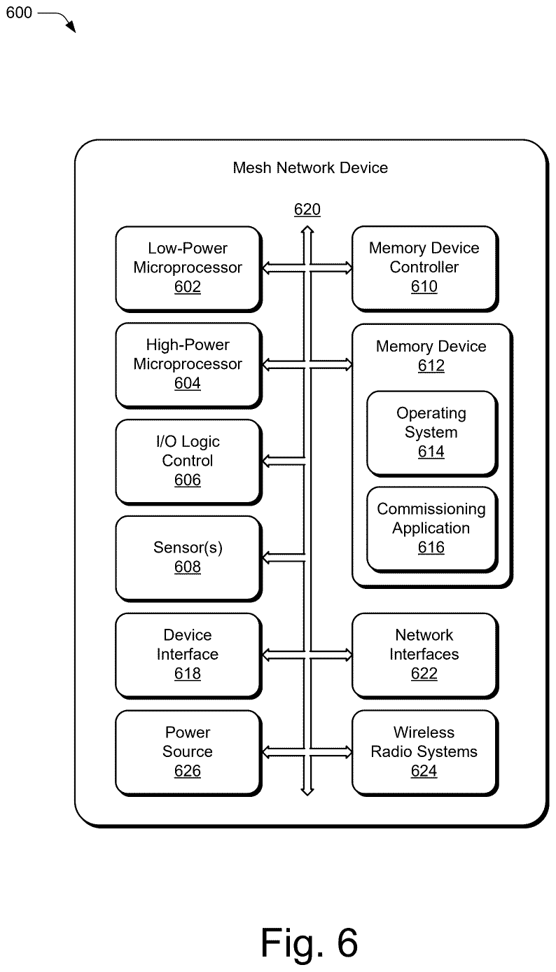

In the environment 500, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 6.

In implementations, the thermostat 502 may include a Nest® Learning Thermostat that detects ambient climate characteristics (e.g., temperature and/or humidity) and controls a HVAC system 514 in the home environment. The learning thermostat 502 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 504 can be implemented to detect the presence of a hazardous substance or a substance indicative of a hazardous substance (e.g., smoke, fire, or carbon monoxide). In examples of wireless interconnection, a hazard detector 504 may detect the presence of smoke, indicating a fire in the structure, in which case the hazard detector that first detects the smoke can broadcast a low-power wake-up signal to all of the connected wireless network devices. The other hazard detectors 504 can then receive the broadcast wake-up signal and initiate a high-power state for hazard detection and to receive wireless communications of alert messages. Further, the lighting units 508 can receive the broadcast wake-up signal and activate in the region of the detected hazard to illuminate and identify the problem area. In another example, the lighting units 508 may activate in one illumination color to indicate a problem area or region in the structure, such as for a detected fire or break-in, and activate in a different illumination color to indicate safe regions and/or escape routes out of the structure.

In various configurations, the wireless network devices 510 can include an entryway interface device 516 that functions in coordination with a network-connected door lock system 518, and that detects and responds to a person's approach to or departure from a location, such as an outer door of the structure 512. The entryway interface device 516 can interact with the other wireless network devices based on whether someone has approached or entered the smart-home environment. An entryway interface device 516 can control doorbell functionality, announce the approach or departure of a person via audio or visual means, and control settings on a security system, such as to activate or deactivate the security system when occupants come and go. The wireless network devices 510 can also include other sensors and detectors, such as to detect ambient lighting conditions, detect room-occupancy states (e.g., with an occupancy sensor 520), and control a power and/or dim state of one or more lights. In some instances, the sensors and/or detectors may also control a power state or speed of a fan, such as a ceiling fan 522. Further, the sensors and/or detectors may detect occupancy in a room or enclosure and control the supply of power to electrical outlets or devices 524, such as if a room or the structure is unoccupied.

The wireless network devices 510 may also include connected appliances and/or controlled systems 526, such as refrigerators, stoves and ovens, washers, dryers, air conditioners, pool heaters 528, irrigation systems 530, security systems 532, and so forth, as well as other electronic and computing devices, such as televisions, network-connected televisions, network-connected media streaming devices, entertainment systems, computers, intercom systems, garage-door openers 534, ceiling fans 522, control panels 536, and the like. When plugged in, an appliance, device, or system can announce itself to the mesh network as described above and can be automatically integrated with the controls and devices of the mesh network, such as in the home. It should be noted that the wireless network devices 510 may include devices physically located outside of the structure, but within wireless communication range, such as a device controlling a swimming pool heater 528 or an irrigation system 530.

As described above, the mesh network 100 includes a border router 106 that interfaces for communication with an external network, outside the mesh network 100. The border router 106 connects to an access point 110, which connects to the communication network 108, such as the Internet. A cloud service 112, which is connected via the communication network 108, provides services related to and/or using the devices within the mesh network 100. By way of example, the cloud service 112 can include applications for connecting end user devices 538, such as smartphones, tablets, and the like, to devices in the mesh network, processing and presenting data acquired in the mesh network 100 to end users, linking devices in one or more mesh networks 100 to user accounts of the cloud service 112, provisioning and updating devices in the mesh network 100, and so forth. For example, a user can control the thermostat 502 and other wireless network devices in the home environment using a network-connected computer or portable device, such as a mobile phone or tablet device. Further, the wireless network devices can communicate information to any central server or cloud-computing system via the border router 202 and the access point 204. The data communications can be carried out using any of a variety of custom or standard wireless protocols (e.g., Wi-Fi, ZigBee for low power, 6LoWPAN, Thread, etc.) and/or by using any of a variety of custom or standard wired protocols (Ethernet, HomePlug, etc.).

Any of the wireless network devices in the mesh network 100 can serve as low-power and communication nodes to create the mesh network 100 in the home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the mesh network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 540 detects that the room is dark and when the occupancy sensor 520 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the mesh network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the mesh network. In other implementations, the mesh network can be used to automatically turn on and off the lighting units 508 as a person transitions from room to room in the structure. For example, the wireless network devices can detect the person's movement through the structure and communicate corresponding messages via the nodes of the mesh network. Using the messages that indicate which rooms are occupied, other wireless network devices that receive the messages can activate and/or deactivate accordingly. As referred to above, the mesh network can also be utilized to provide exit lighting in the event of an emergency, such as by turning on the appropriate lighting units 508 that lead to a safe exit. The light units 508 may also be turned-on to indicate the direction along an exit route that a person should travel to safely exit the structure.

The various wireless network devices may also be implemented to integrate and communicate with wearable computing devices 542, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the mesh network, conforming to the wireless interconnection protocols for communicating on the mesh network.

The wireless network devices 510 may also include a network-connected alarm clock 544 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the mesh network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 502 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 502 so as to pre-heat or cool the environment to a desired setting and turning-on or turning-off the lights 508.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 500 may include one or more wireless network devices that function as a hub 546. The hub 546 may be a general-purpose home automation hub, or an application-specific hub, such as a security hub, an energy management hub, an HVAC hub, and so forth. The functionality of a hub 546 may also be integrated into any wireless network device, such as a network-connected thermostat device or the border router 106. Hosting functionality on the hub 546 in the structure 512 can improve reliability when the user's internet connection is unreliable, can reduce latency of operations that would normally have to connect to the cloud service 112, and can satisfy system and regulatory constraints around local access between wireless network devices.

Additionally, the example environment 500 includes a network-connected-speaker 548. The network-connected speaker 548 provides voice assistant services that include providing voice control of network-connected devices. The functions of the hub 546 may be hosted in the network-connected speaker 548. The network-connected speaker 548 can be configured to communicate via the wireless mesh network 100, the Wi-Fi network 204, or both.

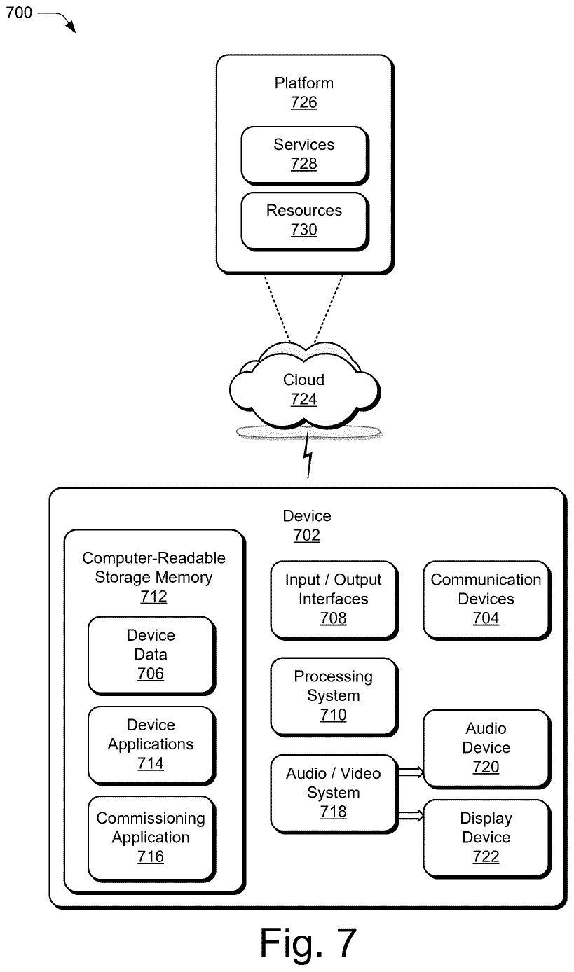

FIG. 6 illustrates an example wireless network device 600 (a Thread device) that can be implemented as any of the mesh network devices in a mesh network (Thread network) in accordance with one or more aspects of ephemeral codes for Thread credential sharing as described herein. The device 600 can be integrated with electronic circuitry, microprocessors, memory, input output (I/O) logic control, communication interfaces and components, as well as other hardware, firmware, and/or software to implement the device in a mesh network. Further, the wireless network device 600 can be implemented with various components, such as with any number and combination of different components as further described with reference to the example device shown in FIG. 7.

In this example, the wireless network device 600 includes a low-power microprocessor 602 and a high-power microprocessor 604 (e.g., microcontrollers or digital signal processors) that process executable instructions. The device also includes an input-output (I/O) logic control 606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 602 and the high-power microprocessor 604 can also support one or more different device functionalities of the device. For example, the high-power microprocessor 604 may execute computationally intensive operations, whereas the low-power microprocessor 602 may manage less-complex processes such as detecting a hazard or temperature from one or more sensors 608. The low-power processor 602 may also wake or initialize the high-power processor 604 for computationally intensive processes.

The one or more sensors 608 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 608 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 600 includes a memory device controller 610 and a memory device 612, such as any type of a nonvolatile memory and/or other suitable electronic data storage device. The wireless network device 600 can also include various firmware and/or software, such as an operating system 614 that is maintained as computer executable instructions by the memory and executed by a microprocessor. The device software may also include a commissioning application 616 that implements aspects of ephemeral codes for Thread credential sharing. The wireless network device 600 also includes a device interface 618 to interface with another device or peripheral component and includes an integrated data bus 620 that couples the various components of the wireless network device for data communication between the components. The data bus in the wireless network device may also be implemented as any one or a combination of different bus structures and/or bus architectures.

The device interface 618 may receive input from a user and/or provide information to the user (e.g., as a user interface), and a received input can be used to determine a setting. The device interface 618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 618 may also receive inputs from any number of peripherals, such as buttons, a keypad, a switch, a microphone, and an imager (e.g., a camera device).

The wireless network device 600 can include network interfaces 622, such as a mesh network interface for communication with other wireless network devices in a mesh network, and an external network interface for network communication, such as via the Internet. The wireless network device 600 also includes wireless radio systems 624 for wireless communication with other wireless network devices via the mesh network interface and for multiple, different wireless communications systems. The wireless radio systems 624 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 600 also includes a power source 626, such as a battery and/or to connect the device to line voltage. An AC power source may also be used to charge the battery of the device.

FIG. 7 illustrates an example system 700 that includes an example device 702, which can be implemented as any of the wireless network devices that implement aspects of ephemeral codes for Thread credential sharing as described with reference to the previous FIGS. 1-6. The example device 702 may be any type of computing device, client device, mobile phone, tablet, communication, entertainment, gaming, media playback, and/or other type of device. Further, the example device 702 may be implemented as any other type of wireless network device that is configured for communication on a mesh network, such as a thermostat, hazard detector, camera, light unit, commissioner device, router, border router, joiner router, joining device, end device, leader, access point, and/or other wireless network devices.

The device 702 includes communication devices 704 that enable wired and/or wireless communication of device data 706, such as data that is communicated between the devices in a mesh network, data that is being received, data scheduled for broadcast, data packets of the data, data that is synched between the devices, etc. The device data can include any type of communication data, as well as audio, video, and/or image data that is generated by applications executing on the device. The communication devices 704 can also include transceivers for cellular phone communication and/or for network data communication.

The device 702 also includes input/output (I/O) interfaces 708, such as data network interfaces that provide connection and/or communication links between the device, data networks (e.g., a mesh network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage memory 712 (computer-readable storage media 712), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 712 provides storage of the device data 706 and various device applications 714, such as an operating system that is maintained as a software application with the computer-readable storage memory and executed by the processing system 710. The device applications may also include a device manager, such as any form of a control application, software application, signal processing and control module, code that is native to a particular device, a hardware abstraction layer for a particular device, and so on. In this example, the device applications also include a commissioning application 716 that implements aspects of ephemeral codes for Thread credential sharing, such as when the example device 702 is implemented as any of the wireless network devices described herein.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device. In aspects, at least part of the techniques described for common interface for ephemeral codes for Thread credential sharing may be implemented in a distributed system, such as over a “cloud” 724 in a platform 726. The cloud 724 includes and/or is representative of the platform 726 for services 728 and/or resources 730.

The platform 726 abstracts underlying functionality of hardware, such as server devices (e.g., included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device aspect with functionality distributed throughout the system 700. For example, the functionality may be implemented in part at the example device 702 as well as via the platform 726 that abstracts the functionality of the cloud 724.

Although aspects of ephemeral codes for Thread credential sharing have been described in language specific to features and/or methods, the subject of the appended claims is not necessarily limited to the specific features or methods described. Rather, the specific features and methods are disclosed as example implementations of ephemeral codes for Thread credential sharing, and other equivalent features and methods are intended to be within the scope of the appended claims. Further, various different aspects are described, and it is to be appreciated that each described aspect can be implemented independently or in connection with one or more other described aspects.

Example 1: A method of joining a first Thread device to a Thread network, in particular a wireless mesh network, by a commissioner device, the method comprising:
discovering, a second Thread device operating on the Thread network;
based on the discovering, requesting an ephemeral code from the second Thread device, the request directing the second Thread device to generate the ephemeral code; and
using the ephemeral code, establishing a secure session with the second Thread device, the establishing being effective to direct the second Thread device to transfer credentials for the Thread network to the first Thread device to enable the first Thread device to join the Thread network.

Example 2: The method of example 1, wherein the discovering the second Thread device comprises:

discovering the second Thread device using Domain Name Service-Service Discovery (DNS-SD) or multicast DNS (mDNS).

Example 3: The method of example 2, wherein the discovering the second Thread device occurs over Wi-Fi or Ethernet.

Example 4: The method of example 1, wherein the discovering the second Thread device comprises:
using DNS-SD over unicast DNS to discover Thread devices that are publishing their services via a Service Registration Protocol (SRP).

Example 5: The method of example 1, wherein the discovering the second Thread device comprises:
using link-layer discovery services over a Thread or IEEE 802.15.4 radio link.

Example 6: The method of at least one of the examples 1 to 5, wherein the discovering the second Thread device further comprises:
querying a cloud-service to discover the second Thread device.

Example 7: The method of any one of the preceding examples, wherein the establishing a secure session comprises:
establishing the secure session using Transport Layer Security (TLS) with Elliptic Curve Cryptography (ECC) variant of Password Authenticated Key Exchange by Juggling (J-PAKE) (ECJ-PAKE); or
establishing the secure session using Datagram Transport Layer Security (DTLS) with ECJ-PAKE.

Example 8: The method of any one of the preceding examples, wherein the second Thread device is a border agent.

Example 9: The method of example 8, wherein the border agent is a border router.

Example 10: The method of any one of the preceding examples, wherein the ephemeral code is a time-limited passcode, in particular a random, single-use, time-limited passcode, a passcode comprising human-readable character and/or a passcode comprising a machine-readable image.

Example 11: The method of any one of the preceding examples, wherein the ephemeral code includes eight random numeric digits and one check digit.

Example 12: The method of any one of the preceding claims, wherein the transfer of the credentials for the Thread network to the first Thread device comprises:
the second Thread device transferring the credentials; or
the commissioning device transferring the credentials.

Example 13. A method for merging a first Thread network, in particular a wireless mesh network with a second Thread network, in particular a wireless mesh network, the method comprising:
requesting a first Thread device in the first Thread network to generate an ephemeral code;
providing the ephemeral code to a second Thread device in the second Thread network that is effective to direct the second Thread device to:
use the ephemeral code to establish a secure session with the first Thread device; and
negotiate, with the first Thread device, common Thread credentials to use for the merged network, the negotiating being effective to merge the first Thread network and the second Thread network into a single Thread network that uses the common Thread credentials.

Example 14: The method of example 13, wherein the establishing a secure session comprises:
establishing the secure session using Transport Layer Security (TLS) with Elliptic Curve Cryptography (ECC) variant of Password Authenticated Key Exchange by Juggling (J-PAKE) (ECJ-PAKE); or
establishing the secure session using Datagram Transport Layer Security (DTLS) with ECJ-PAKE.

Example 14: The method of example 13, wherein the common Thread credentials comprise one of:
credentials of the first Thread network;
credentials of the second Thread network; or
credentials that are different than those of the first Thread network or the second Thread network.

Example 16: The method of any one of the examples 13 to 15, wherein the ephemeral code is a time-limited passcode, in particular a random, single-use, time-limited passcode, a passcode comprising human-readable character and/or a passcode comprising a machine-readable image.

Example 17: An apparatus comprising:
a processor; and
instructions executable by the processor to configure the apparatus to perform a method as recited by any one of the preceding examples.

1. A method of joining a first Thread device to a Thread network, in particular a wireless mesh network, by a commissioner device, the method comprising:
discovering, a second Thread device operating on the Thread network;
based on the discovering, requesting an ephemeral code from the second Thread device, the request directing the second Thread device to generate the ephemeral code; and
using the ephemeral code, establishing a secure session with the second Thread device, the establishing being effective to transfer credentials for the Thread network to the first Thread device to enable the first Thread device to join the Thread network.

2. The method of claim 1, wherein the discovering the second Thread device comprises:
discovering the second Thread device using Domain Name Service-Service Discovery (DNS-SD) or multicast DNS (mDNS).

3. The method of claim 2, wherein the discovering the second Thread device occurs over Wi-Fi or Ethernet.

4. The method of claim 1, wherein the discovering the second Thread device comprises:
using DNS-SD over unicast DNS to discover Thread devices that are publishing their services via a Service Registration Protocol (SRP).

5. The method of claim 1, wherein the discovering the second Thread device comprises:
using link-layer discovery services over a Thread or IEEE 802.15.4 radio link.

6. The method of claim 1, wherein the discovering the second Thread device further comprises:
querying a cloud-service to discover the second Thread device.

7. The method of claim 1, wherein the establishing a secure session comprises:
establishing the secure session using Transport Layer Security (TLS) with Elliptic Curve Cryptography (ECC) variant of Password Authenticated Key Exchange by Juggling (J-PAKE) (ECJ-PAKE); or
establishing the secure session using Datagram Transport Layer Security (DTLS) with ECJ-PAKE.

8. The method of claim 1, wherein the second Thread device is a border agent.

9. The method of claim 8, wherein the border agent is a border router.

10. The method of claim 1, wherein the ephemeral code is a time-limited passcode, in particular a random, single-use, time-limited passcode, a passcode comprising human-readable character and/or a passcode comprising a machine-readable image.

11. The method of claim 1, wherein the ephemeral code includes eight random numeric digits and one check digit.

12. The method of claim 1, wherein the transfer of the credentials for the Thread network to the first Thread device comprises:
the second Thread device transferring the credentials; or
the commissioning device transferring the credentials.

13. A method for merging a first Thread network, in particular a wireless mesh network with a second Thread network, in particular a wireless mesh network, the method comprising:
requesting a first Thread device in the first Thread network to generate an ephemeral code;
providing the ephemeral code to a second Thread device in the second Thread network that is effective to direct the second Thread device to:
use the ephemeral code to establish a secure session with the first Thread device; and
negotiate, with the first Thread device, common Thread credentials to use for the merged network, the negotiating being effective to merge the first Thread network and the second Thread network into a single Thread network that uses the common Thread credentials.

14. The method of claim 13, wherein the establishing a secure session comprises:
establishing the secure session using Transport Layer Security (TLS) with Elliptic Curve Cryptography (ECC) variant of Password Authenticated Key Exchange by Juggling (J-PAKE) (ECJ-PAKE); or
establishing the secure session using Datagram Transport Layer Security (DTLS) with ECJ-PAKE.

15. The method of claim 13, wherein the common Thread credentials comprise one of:
credentials of the first Thread network;
credentials of the second Thread network; or
credentials that are different than those of the first Thread network or the second Thread network.

16. The method of claim 13, wherein the ephemeral code is a time-limited passcode, in particular a random, single-use, time-limited passcode, a passcode comprising human-readable character and/or a passcode comprising a machine-readable image.

17. A Thread device comprising:
a processor; and
instructions executable by the processor to configure the Thread device to:
discover, a second Thread device operating on a Thread network;
based on the discovery of the second Thread device, request an ephemeral code from the second Thread device, the request directing the second Thread device to generate the ephemeral code; and
using the ephemeral code, establish a secure session with the second Thread device, the establishment of the secure session being effective to transfer credentials for the Thread network to the Thread device to enable the Thread device to join the Thread network.

18. The Thread device of claim 17, wherein the instructions to discover the second Thread device are executable by the processor to configure the Thread device to:
discover the second Thread device using Domain Name Service-Service Discovery (DNS-SD) or multicast DNS (mDNS).

19. The Thread device of claim 18, wherein the discovery of the second Thread device occurs over Wi-Fi or Ethernet.

20. The Thread device of claim 17, wherein the instructions for the discovery of the second Thread device are executable to configure the Thread device to:
use DNS-SD over unicast DNS to discover Thread devices that are publishing their services via a Service Registration Protocol (SRP);
use link-layer discovery services over a Thread or IEEE 802.15.4 radio link; or
query a cloud-service to discover the second Thread device.
